(19) United States
(12) Patent Application Publication
(10) Pub. No.: US 2026/0268825 A1
(43) Pub. Date: Sep. 10, 2026

(54) DISPLAY DEVICE AND ELECTRONIC DEVICE INCLUDING THE SAME

(71) Applicant: Samsung Display Co., Ltd., Yongin-si (KR)

(72) Inventors: Kyeongmin Park, Yongin-si (KR); GYUNGSOON PARK, Yongin-si (KR); Dongwan Ha, Yongin-si (KR)

(21) Appl. No.: 19/541,705

(22) Filed: Feb. 17, 2026

(30) Foreign Application Priority Data
Mar. 10, 2025 (KR) 10-2025-0030882

(51) Int. Cl. G09G 3/20

(52) U.S. Cl. CPC G09G 3/20; G09G 2300/0842; G09G 2310/0297; G09G 2310/08; G09G 2320/0233

(57) ABSTRACT

A display device includes a display panel including a pixel row including pixels, and a first gate line and a second gate line connected to the pixel row, each of the pixels including sub-pixels, a gate driver which provides a first gate signal and a second gate signal to the first gate line and the second gate line, a data driver to provide data voltages, and a demultiplexer which selectively provides the data voltages from the data driver to the sub-pixels of the pixels in response to a first selection signal, a second selection signal, and a third selection signal. The demultiplexer includes a first selection transistor including a gate connected to a first selection line, a second selection transistor including a gate connected to a second selection line which transmits the second selection signal, and a third selection transistor including a gate connected to a third selection line.

This application claims priority to Korean Patent Application No. 10-2025-0030882, filed on Mar. 10, 2025, and all the benefits accruing therefrom under 35 U.S.C. § 119, the content of which in its entirety is herein incorporated by reference.

### BACKGROUND

### 1. Field

Embodiments relate to a display device. More particularly, embodiments relate to a display device including a demultiplexer and an electronic device including the display device.

### 2. Description of the Related Art

A display device may include a display panel, a gate driver, and a data driver. The display panel may include a plurality of gate lines, a plurality of data lines, and a plurality of sub-pixels connected to the gate lines and the data lines. The gate driver may provide gate signals to the gate lines. The data driver may provide data voltages to the data lines.

The display device may further include a demultiplexer. The demultiplexer may selectively provide the data voltages output from the data driver to the data lines. As the display device includes the demultiplexer, the number of channels of the data driver which output the data voltages may be reduced, and dead space of the display device may be reduced.

### SUMMARY

Embodiments provide a display device with reduced data writing error and an electronic device including the display device.

A display device according to embodiments includes a display panel including a pixel row including pixels arranged in a first direction, and a first gate line and a second gate line connected to the pixel row, where each of the pixels includes sub-pixels arranged in the first direction, a gate driver to provide a first gate signal and a second gate signal shifted by ⅓ horizontal time interval of the first gate signal to the first gate line and the second gate line, a data driver which provides data voltages, and a demultiplexer which selectively provides the data voltages from the data driver to the sub-pixels of the pixels in response to a first selection signal, a second selection signal shifted by ⅓ horizontal time interval of the first selection signal, and a third selection signal shifted by ⅓ horizontal time interval of the second selection signal. In such embodiments, the demultiplexer includes a first selection transistor including a gate connected to a first selection line, a second selection transistor including a gate connected to a second selection line which transmits the second selection signal, and a third selection transistor including a gate connected to a third selection line.

In an embodiment, in an odd frame, the gate driver may transmit the first gate signal and the second gate signal to the first gate line and the second gate line, respectively, in response to a dithering signal, and the demultiplexer may transmit the first selection signal and the third selection signal to the first selection line and the third selection line, respectively, in response to the dithering signal. In such an embodiment, in an even frame, the gate driver may transmit the second gate signal and the first gate signal to the first gate line and the second gate line, respectively, in response to the dithering signal, and the demultiplexer may transmit the third selection signal and the first selection signal to the first selection line and the third selection line, respectively, in response to the dithering signal.

In an embodiment, the dithering signal may have a logic high level in the odd frame, and may have a logic low level in the even frame.

In an embodiment, the gate driver may include a first inverter which outputs an inverted dithering signal generated by inverting the dithering signal, a first switch which transmits a first clock signal to a first clock line in response to the dithering signal, a second switch which transmits a second clock signal to a second clock line in response to the dithering signal, a third switch which transmits the first clock signal to the second clock line in response to the inverted dithering signal, and a fourth switch which transmits the second clock signal to the first clock line in response to the inverted dithering signal.

In an embodiment, the gate driver may include a second inverter which outputs an inverted dithering signal generated by inverting the dithering signal, a fifth switch which transmits the first selection signal to the first selection line in response to the dithering signal, a sixth switch which transmits the third selection signal to the third selection line in response to the dithering signal, a seventh switch which transmits the first selection signal to the third selection line in response to the inverted dithering signal, and an eighth switch which transmits the third selection signal to the first selection line in response to the inverted dithering signal.

In an embodiment, the first gate line and the second gate line may be alternately connected to the pixel row on a pixel-by-pixel basis.

In an embodiment, the first gate line and the second gate line may be alternately connected to the pixel row on a sub-pixel by sub-pixel basis.

In an embodiment, each of the first gate signal and the second gate signal may have a pulse having a width corresponding to ⅔ horizontal time interval. In such an embodiment, the pulse of the first gate signal and the pulse of the second gate signal may partially overlap each other.

In an embodiment, each of the first selection signal, the second selection signal, and the third selection signal may have a pulse having a width corresponding to ⅓ horizontal time interval. In such an embodiment, the pulse of the first selection signal, the pulse of the second selection signal, and the pulse of the third selection signal may not overlap each other.

In an embodiment, the display panel may further include a third gate line connected to the pixel row. In such an embodiment, the gate driver may provide the first gate signal, the second gate signal, and a third gate signal shifted by ⅓ horizontal time interval of the second gate signal to the first gate line, the second gate line, and the third gate line, respectively.

In an embodiment, the first gate line, the second gate line, and the third gate line may be alternately connected to the pixel row on a pixel-by-pixel basis.

In an embodiment, the first gate line, the second gate line, and the third gate line may be alternately connected to the pixel row on a sub-pixel by sub-pixel basis.

In an embodiment, each of the first gate signal, the second gate signal, and the third gate signal may have a pulse having a width corresponding to one horizontal time interval. In such an embodiment, the pulse of the first gate signal, the pulse of the second gate signal, and the pulse of the third gate signal may partially overlap each other.

An electronic device according to embodiments includes a processor, and a display device to receive input image data from the processor, where the display device displays an image corresponding to the input image data. In such embodiments, the display device includes a display panel including a pixel row including pixels arranged in a first direction, and a first gate line and a second gate line connected to the pixel row, where each of the pixels includes sub-pixels arranged in the first direction, a gate driver which provides a first gate signal and a second gate signal shifted by ⅓ horizontal time interval of the first gate signal to the first gate line and the second gate line, a data driver which provides data voltages, and a demultiplexer which selectively provides the data voltages from the data driver to the sub-pixels of the pixels in response to a first selection signal, a second selection signal shifted by ⅓ horizontal time interval of the first selection signal, and a third selection signal shifted by ⅓ horizontal time interval of the second selection signal. In such embodiments, the demultiplexer includes a first selection transistor including a gate connected to a first selection line, a second selection transistor including a gate connected to a second selection line which transmits the second selection signal, and a third selection transistor including a gate connected to a third selection line.

In an embodiment, in an odd frame, the gate driver may transmit the first gate signal and the second gate signal to the first gate line and the second gate line, respectively, in response to a dithering signal, and the demultiplexer may transmit the first selection signal and the third selection signal to the first selection line and the third selection line, respectively, in response to the dithering signal. In such an embodiment, in an even frame, the gate driver may transmit the second gate signal and the first gate signal to the first gate line and the second gate line, respectively, in response to the dithering signal, and the demultiplexer may transmit the third selection signal and the first selection signal to the first selection line and the third selection line, respectively, in response to the dithering signal.

In an embodiment, the dithering signal may have a logic high level in the odd frame, and may have a logic low level in the even frame.

In an embodiment, the first gate line and the second gate line may be alternately connected to the pixel row on a pixel-by-pixel basis.

In an embodiment, the first gate line and the second gate line may be alternately connected to the pixel row on a sub-pixel by sub-pixel basis.

In an embodiment, each of the first gate signal and the second gate signal may have a pulse having a width corresponding to ⅔ horizontal time interval. In such an embodiment, the pulse of the first gate signal and the pulse of the second gate signal may partially overlap each other.

In an embodiment, each of the first selection signal, the second selection signal, and the third selection signal may have a pulse having a width corresponding to ⅓ horizontal time interval. In such an embodiment, the pulse of the first selection signal, the pulse of the second selection signal, and the pulse of the third selection signal may not overlap each other.

In the display device and the electronic device according to embodiments of the disclosure, a plurality of gate lines are connected to one pixel row, such that a parasitic capacitance of the gate line may decrease, and the data writing error may be substantially reduced or effectively prevented. In such embodiments, in the odd frame and the even frame, the dithering signal may be used to switch the first gate signal and the second gate signal, and to switch the first selection signal and the third selection signal, such that a luminance difference between areas of the display device may be improved.

### BRIEF DESCRIPTION OF THE DRAWINGS

Illustrative, non-limiting embodiments will be more clearly understood from the following detailed description taken in conjunction with the accompanying drawings.

FIG. 1 is a block diagram illustrating a display device according to an embodiment.

FIG. 2 is a block diagram illustrating a display device according to an embodiment.

FIG. 3 is a signal timing diagram illustrating gate signals and selection signals of FIG. 2.

FIG. 4 is a circuit diagram illustrating sub-pixels of FIG. 2.

FIG. 5 is a block diagram illustrating a display device according to a comparative example.

FIG. 6 is a signal timing diagram illustrating gate signals and selection signals of FIG. 5.

FIG. 7 is a circuit diagram illustrating sub-pixels of FIG. 5.

FIG. 8 is a block diagram illustrating a display device according to an embodiment.

FIG. 9 is a signal timing diagram illustrating a dithering signal, signals of gate lines, and signals of selection lines of FIG. 8.

FIG. 10 is a block diagram illustrating a display device according to an embodiment.

FIG. 11 is a block diagram illustrating a display device according to an embodiment.

FIG. 12 is a block diagram illustrating a display device according to an embodiment.

FIG. 13 is a signal timing diagram illustrating gate signals and selection signals o FIG. 12.

FIG. 14 is a block diagram illustrating a display device according to an embodiment.

FIG. 15 is a block diagram illustrating an electronic device according to an embodiment.

FIG. 16 is a diagram illustrating electronic devices according to embodiments.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, a display device and an electronic device according to embodiments of the present disclosure will be described in more detail with reference to the accompanying drawings.

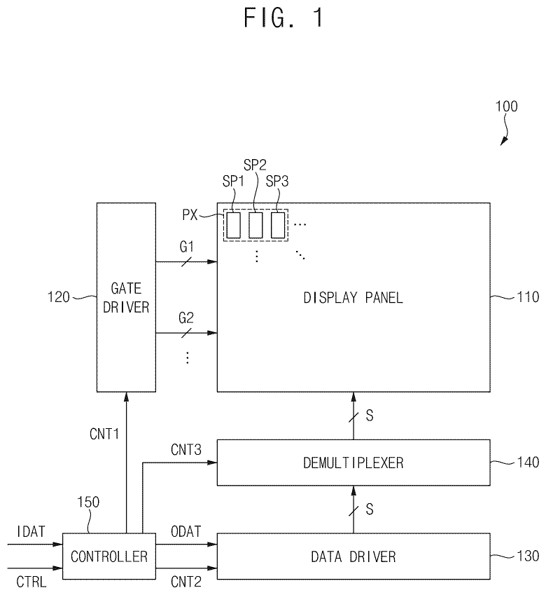

FIG. 1 is a block diagram illustrating a display device 100 according to an embodiment.

Referring to FIG. 1, an embodiment of the display device 100 may include a display panel 110, a gate driver 120, a data driver 130, a demultiplexer 140, and a controller 150.

The display panel 110 may include a plurality of pixel rows. Each of the pixel rows may include a plurality of pixels PX. Each of the pixels PX may include a plurality of sub-pixels. In an embodiment, each of the pixels PX may include a first sub-pixel SP1, a second sub-pixel SP2, and a third sub-pixel SP3. The first sub-pixel SP1, the second sub-pixel SP2, and the third sub-pixel SP3 may emit light having different colors from each other.

The gate driver 120 may provide a plurality of gate signals G1, G2, . . . to the pixel rows, respectively. The gate driver 120 may generate the gate signals G1, G2, . . . based on a first control signal CNT1. In an embodiment, the first control signal CNT1 may include a gate start signal, a plurality of clock signals, etc.

The data driver 130 may provide a plurality of data voltages S. The data driver 130 may include a plurality of channels that output the data voltages S, respectively. The data driver 130 may generate the data voltages S based on output image data ODAT and a second control signal CNT2. In an embodiment, the second control signal CNT2 may include a load signal, a data clock signal, an output data enable signal, etc.

The demultiplexer 140 may selectively provide the data voltages S to the sub-pixels SP1, SP2, and SP3 of the pixels PX based on a third control signal CNT3. The third control signal CNT3 may include a plurality of selection signals. As the demultiplexer 140 selectively provides the data voltages S to the sub-pixels SP1, SP2, and SP3 of the pixels PX, the number of channels of the data driver 130 may be reduced.

The controller 150 may control the gate driver 120, the data driver 130, and the demultiplexer 140. The controller 150 may provide the first control signal CNT1 to the gate driver 120, may provide the output image data ODAT and the second control signal CNT2 to the data driver 130, and may provide the third control signal CNT3 to the demultiplexer 140. The controller 150 may generate the output image data ODAT, the first control signal CNT1, the second control signal CNT2, and the third control signal CNT3 based on input image data IDAT and a control signal CTRL. The control signal CTRL may include a horizontal synchronization signal, a vertical synchronization signal, an input data enable signal, etc.

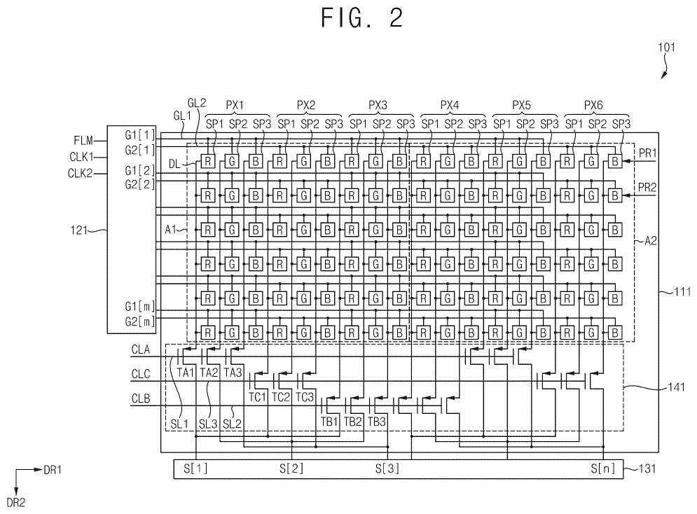

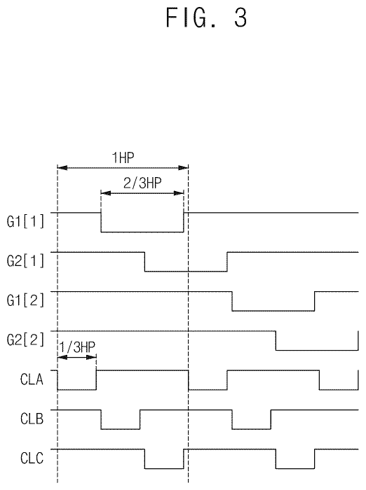

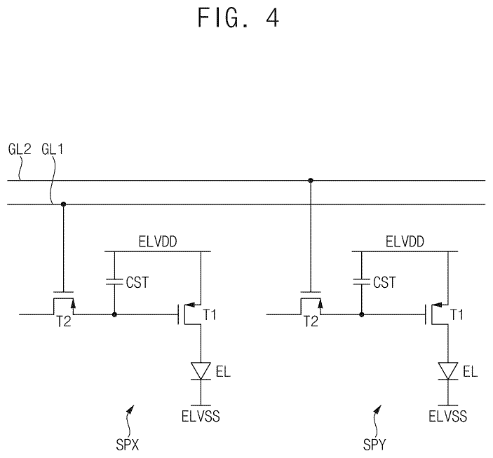

FIG. 2 is a block diagram illustrating a display device 101 according to an embodiment. FIG. 3 is a signal timing diagram illustrating gate signals G1[1], G2[1], G1[2], and G2[2] and selection signals CLA, CLB, and CLC of FIG. 2. FIG. 4 is a circuit diagram illustrating sub-pixels SPX and SPY of FIG. 2.

Referring to FIGS. 2 to 4, the display device 101 according to an embodiment may include a display panel 111, a gate driver 121, a data driver 131, and a demultiplexer 141.

The display panel 111 may include a plurality of pixel rows PR1, PR2, . . . , a plurality of first gate lines GL1, a plurality of second gate lines GL2, and a plurality of data lines DL.

The pixel rows PR1, PR2, . . . may extend in a first direction DR1, and may be arranged in a second direction DR2 intersecting the first direction DR1. Each of the pixel rows PR1, PR2, . . . may include a plurality of pixels PX1, PX2, PX3, PX4, PX5, PX6, . . . arranged in the first direction DR1. Each of the pixels PX1, PX2, PX3, PX4, PX5, PX6, . . . may include first to third sub-pixels SP1, SP2, and SP3 arranged in the first direction DR1. In an embodiment, the first sub-pixel SP1, the second sub-pixel SP2, and the third sub-pixel SP3 may be a red sub-pixel R, a green sub-pixel G, and a blue sub-pixel B, respectively.

The first gate lines GL1 and the second gate lines GL2 may extend in the first direction DR1, and may be arranged in the second direction DR2. Each of the first gate lines GL1 and each of the second gate lines GL2 may be connected to a corresponding pixel row among the pixel rows PR1, PR2, . . . . In an embodiment, one first gate line GL1 and one second gate line GL2 may be connected to one pixel row.

The first gate line GL1 and the second gate line GL2 may be alternately connected to the pixels PX in the pixel row on a pixel-by-pixel basis. In an embodiment, the first gate line GL1 may be connected to the sub-pixels SP1, SP2, and SP3 of odd (odd-numbered) pixels PX1, PX3, PX5, . . . in the first direction DR1, and the second gate line GL2 may be connected to the sub-pixels SP1, SP2, and SP3 of even (even-numbered) pixels PX2, PX4, PX6, . . . in the first direction DR1.

The data lines DL may extend in the second direction DR2, and may be arranged in the first direction DR1.

The gate driver 121 may provide a plurality of first gate signals G1[1], G1[2], . . . , G1[m] to the first gate lines GL1, and may provide a plurality of second gate signals G2[1], G2[2], . . . , G2[m] to the second gate lines GL2. The gate driver 121 may provide a first first gate signal G1[1] to the first gate line GL1 connected to the first pixel row PR1, may provide a first second gate signal G2[1] to the second gate line GL2 connected to the first pixel row PR1, may provide a second first gate signal G1[2] to the first gate line GL1 connected to the second pixel row PR2, and may provide a second second gate signal G2[2] to the second gate line GL2 connected to the second pixel row PR2. The gate driver 121 may generate the first gate signals G1[1], G1[2], . . . , G1[m] based on the gate start signal FLM and a first clock signal CLK1, and may generate the second gate signals G2[1], G2[2], . . . , G2[m] based on the gate start signal FLM and a second clock signal CLK2.

The second gate signal G2[1], G2[2], . . . , G2[m] may be a signal in which the first gate signal G1[1], G1[2], . . . , G1[m] is shifted by ⅓ horizontal time interval ⅓HP. In an embodiment, each of the first gate signal G1[1], G1[2], . . . , G1[m] and the second gate signal G2[1], G2[2], . . . , G2[m] may have a pulse having a width corresponding to (e.g., equal to) ⅔ horizontal time interval ⅔HP, and the pulse of the first gate signal G1[1], G1[2], . . . , G1[m] and the pulse of the second gate signal G2[1], G2[2], . . . , G2[m] may partially overlap each other.

The data driver 131 may provide data voltages S[1], S[2], S[3], . . . , S[n] to the demultiplexer 141.

The demultiplexer 141 may selectively provide the data voltages S[1], S[2], S[3], . . . , S[n] to the sub-pixels SP1, SP2, and SP3 of the pixels PX1, PX2, PX3, PX4, PX5, PX6, . . . in response to a first selection signal CLA, a second selection signal CLB, and a third selection signal CLC. The demultiplexer 141 may include a first selection line SL1, a second selection line SL2, a third selection line SL3, first selection transistors TA1, TA2, and TA3, second selection transistors TB1, TB2, and TB3, and third selection transistors TC1, TC2, and TC3. The first selection line SL1 may transmit the first selection signal CLA, the second selection line SL2 may transmit the second selection signal CLB, and the third selection line SL3 may transmit the third selection signal CLC.

Each of the first selection transistors TA1, TA2, and TA3 may include a gate connected to the first selection line SL1, a first terminal that receives a corresponding data voltage S[1], S[2], S[3], . . . , S[n], and a second terminal connected to a corresponding data line DL. Each of the second selection transistors TB1, TB2, and TB3 may include a gate connected to the second selection line SL2, a first terminal that receives a corresponding data voltage S[1], S[2], S[3], . . . , S[n], and a second terminal connected to a corresponding data line DL. Each of the third selection transistors TC1, TC2, and TC3 may include a gate connected to the third selection line SL3, a first terminal that receives a corresponding data voltage S[1], S[2], S[3], . . . , S[n], and a second terminal connected to a corresponding data line DL.

The second selection signal CLB may be a signal in which the first selection signal CLA is shifted by ⅓ horizontal time interval ⅓HP, and the third selection signal CLC may be a signal in which the second selection signal CLB is shifted by ⅓ horizontal time interval ⅓HP. In an embodiment, each of the first selection signal CLA, the second selection signal CLB, and the third selection signal CLC may have a pulse having a width corresponding to (e.g., equal to) ⅓ horizontal time interval ⅓HP, and the pulse of the first selection signal CLA, the pulse of the second selection signal CLB, and the pulse of the third selection signal CLC may not overlap each other.

When the first selection transistors TA1, TA2, and TA3 are turned on in response to the pulse of the first selection signal CLA, the data voltages S[1], S[2], and S[3] may be charged to the data lines DL connected to the sub-pixels SP1, SP2, and SP3 of the first pixel PX1. When the second selection transistors TB1, TB2, and TB3 are turned on in response to the pulse of the second selection signal CLB, the data voltages S[1], S[2], and S[3] may be charged to the data lines DL connected to the sub-pixels SP1, SP2, and SP3 of the third pixel PX3. The data voltages S[1], S[2], and S[3] charged to the data lines DL may be written to the sub-pixels SP1, SP2, and SP3 of the first and third pixels PX1 and PX3 in response to the pulse of the first gate signal G1[1], G1[2], . . . .

When the third selection transistors TC1, TC2, and TC3 are turned on in response to the pulse of the third selection signal CLC, the data voltages S[1], S[2], and S[3] may be charged to the data lines DL connected to the sub-pixels SP1, SP2, and SP3 of the second pixel PX2. The data voltages S[1], S[2], and S[3] charged to the data lines DL may be written to the sub-pixels SP1, SP2, and SP3 of the second pixel PX2 in response to the pulse of the second gate signal G2[1], G2[2], . . . .

In an embodiment, as illustrated in FIG. 4, each of the sub-pixels SPX and SPY may include a first transistor T1, a second transistor T2, a capacitor CST, and a light-emitting element EL. The second transistor T2 may write a data voltage to the capacitor CST in response to a corresponding gate signal among the first and second gate signals. The capacitor CST may store the written data voltage. The first transistor T1 may generate a driving current corresponding to the data voltage stored in the capacitor CST. The light-emitting element EL may emit light with a luminance corresponding to the driving current generated by the first transistor T1.

Half of the sub-pixels SPX among the sub-pixels SP1, SP2, and SP3 included in one pixel row may be connected to the first gate line GL1, and the remaining half of the sub-pixels SPY may be connected to the second gate line GL2. A parasitic capacitance Cp of each of the first gate line GL1 and the second gate line GL2 may be calculated by mathematical expression 1.

$$Cp = n \times Cw + n / 2 \times Cgg \qquad [ Mathematical expression 1 ]$$

In mathematical expression 1, n denotes the number of sub-pixels SP1, SP2, and SP3 included in one pixel row, Cw denotes a wiring capacitance, and Cgg denotes a capacitance between a gate and a channel of the second transistor T2.

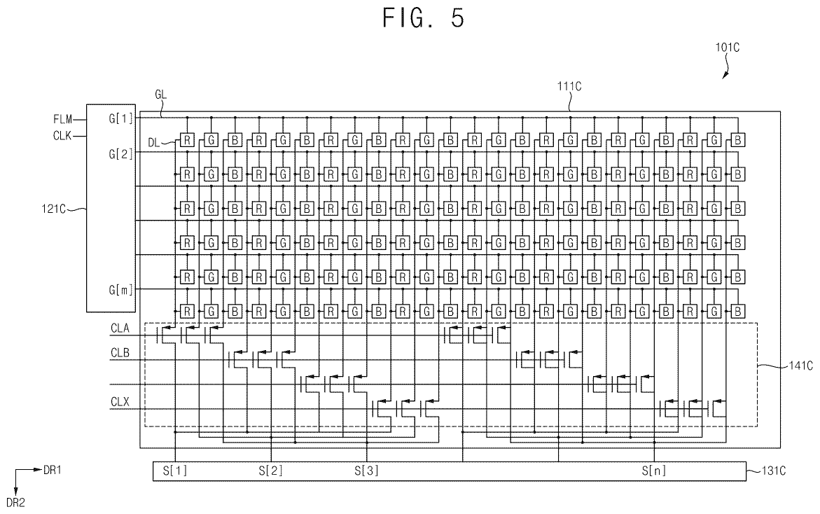

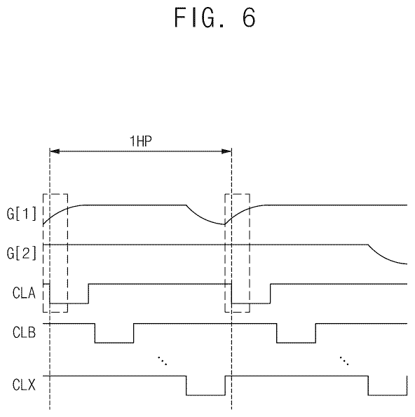

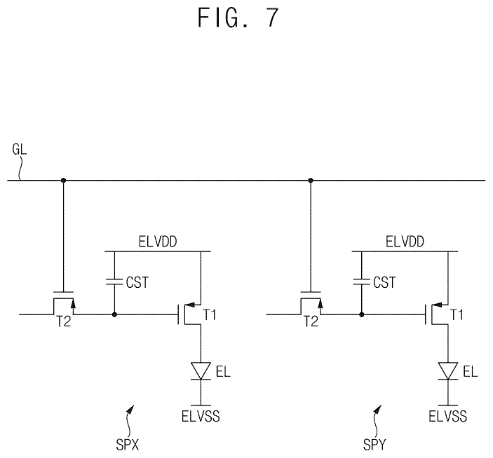

FIG. 5 is a block diagram illustrating a display device 101C according to a comparative example. FIG. 6 is a signal timing diagram illustrating gate signals G[1] and G[2] and selection signals CLA, CLB, . . . , CLX of FIG. 5. FIG. 7 is a circuit diagram illustrating sub-pixels SPX and SPY of FIG. 5.

Referring to FIGS. 5 to 7, the display device 101C according to a comparative example may include a display panel 111C, a gate driver 121C, a data driver 131C, and a demultiplexer 141C. The display panel 111C may include a plurality of pixel rows, a plurality of gate lines GL, and a plurality of data lines DL.

The gate lines GL may extend in the first direction DR1, and may be arranged in the second direction DR2. Each of the gate lines GL may be connected to all sub-pixels included in a corresponding pixel row among the pixel rows. In the comparative example, one gate line GL may be connected to all sub-pixels included in one pixel row.

The gate driver 121C may provide a plurality of gate signals G[1], G[2], . . . , G[m] to the gate lines GL. The gate driver 121C may generate the gate signals G[1], G[2], . . . , G[m] based on the gate start signal FLM and a clock signal CLK.

The demultiplexer 141C may selectively provide data voltages S[1], S[2], S[3], . . . , S[n] to the sub-pixels of the pixels in response to selection signals CLA, CLB, . . . , CLX. The data voltages S[1], S[2], and S[3] may be charged to the data lines DL in response to pulses of the selection signals CLA, CLB, . . . , CLX. The data voltages S[1], S[2], and S[3] charged to the data lines DL may be written to the sub-pixels in response to pulses of the gate signals G[1], G[2], . . . .

A slew rate of the gate signal G[1], G[2], . . . may decrease when the parasitic capacitance of the gate line GL increases, and falling and rising of the gate signal G[1], G[2], . . . may be delayed (a falling time and a rising time of the gate signal G[1], G[2], . . . may increase). Accordingly, as illustrated in FIG. 6, a shape of the pulse of the gate signal G[1], G[2], . . . may be distorted, and data writing error may occur.

In the comparative example, as illustrated in FIG. 7, all sub-pixels SPX and SPY included in one pixel row may be connected to the gate line GL. A parasitic capacitance Cp′ of the gate line GL may be calculated by mathematical expression 2.

$${Cp}^{′} = n \times Cw + n \times Cgg \qquad [ Mathematical expression 2 ]$$

In Mathematical expression 2, n denotes the number of sub-pixels SP1, SP2, and SP3 included in one pixel row, Cw denotes a wiring capacitance, and Cgg denotes a capacitance between a gate and a channel of the second transistor T2

In an embodiment described with reference to FIGS. 2 to 4, two gate lines GL1 and GL2 may be connected to one pixel row, and some (e.g., half) of the sub-pixels SPX included in one pixel row may be connected to the first gate line GL1, and the remaining sub-pixels SPY may be connected to the second gate line GL2. Accordingly, the parasitic capacitance Cp of the gate lines GL1 and GL2 according to an embodiment may be less than the parasitic capacitance Cp′ of the gate line GL according to the comparative example, and the slew rate of the gate signal transmitted by the gate line GL1 and GL2 may increase. Accordingly, in an embodiment, the data writing error may be substantially reduced or effectively prevented.

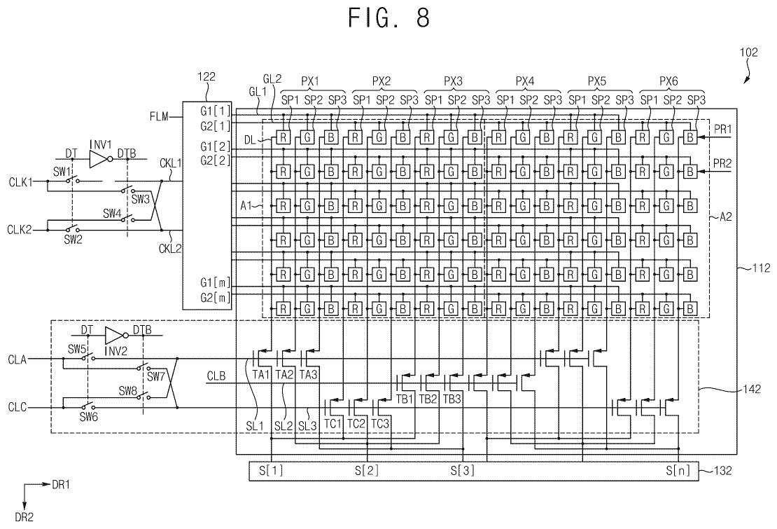

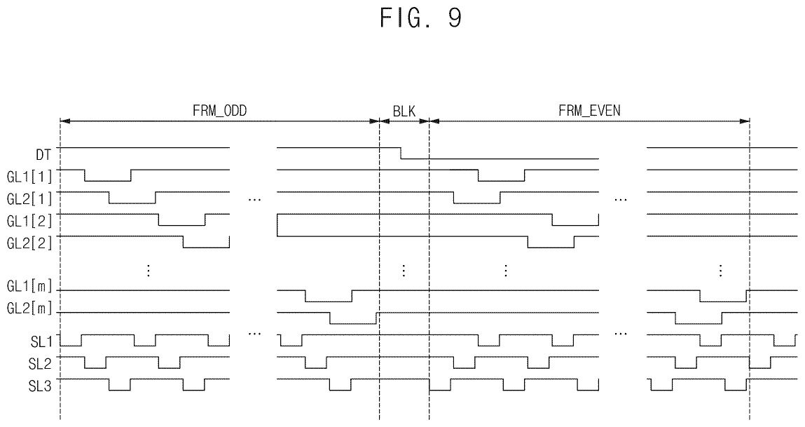

FIG. 8 is a block diagram illustrating a display device 102 according to an embodiment. FIG. 9 is a signal timing diagram illustrating a dithering signal DT, signals of gate lines GL1[1], GL2[1], GL1[2], GL2[2], GL1[m], and GL2[m], and signals of selection lines SL1, SL2, and SL3 of FIG. 8.

For convenience of description, any repetitive detailed descriptions of the same or like components of the display device 102 shown in FIGS. 8 and 9, which are substantially the same as or similar to those of the display device 101 described above with reference to FIGS. 2 and 3, will be omitted or simplified.

Referring to FIGS. 8 and 9, an embodiment of the display device 102 may include a display panel 112, a gate driver 122, a data driver 132, and a demultiplexer 142.

The display panel 112 may include a plurality of pixel rows PR1, PR2, . . . , a plurality of first gate lines GL1, a plurality of second gate lines GL2, and a plurality of data lines DL.

The gate driver 122 may provide first gate signals G1[1], G1[2], . . . , G1[m] and second gate signals G2[1], G2[2], . . . , G2[m] to the first gate lines GL1 and the second gate lines GL2. The gate driver 122 may provide a first first gate signal G1[1] and a first second gate signal G2[1] to the first gate line GL1 and the second gate line GL2 connected to the first pixel row PR1, and may provide a second first gate signal G1[2] and a second second gate signal G2[2] to the first gate line GL1 and the second gate line GL2 connected to the second pixel row PR2. The gate driver 122 may generate the first gate signals G1[1], G1[2], . . . , G1[m] and the second gate signals G2[1], G2[2], . . . , G2[m] based on the gate start signal FLM, the first clock signal CLK1, the second clock signal CLK2, and a dithering signal DT. In an embodiment, the dithering signal DT may have a logic high level in an odd frame FRM_ODD, and may have a logic low level in an even frame FRM_EVEN.

In the odd frame FRM_ODD, the gate driver 122 may transmit the first gate signals G1[1], G1[2], . . . , G1[m] and the second gate signals G2[1], G2[2], . . . , G2[m] to the first gate lines GL1 and the second gate lines GL2, respectively, in response to the dithering signal DT. In the even frame FRM_EVEN, the gate driver 122 may transmit the second gate signals G2[1], G2[2], . . . , G2[m] and the first gate signals G1[1], G1[2], . . . , G1[m] to the first gate lines GL1 and the second gate lines GL2, respectively, in response to the dithering signal DT. Accordingly, signals of the first gate lines GL1[1], GL1[2], . . . , GL1[m] may be the first gate signals G1[1], G1[2], . . . , G1[m] in the odd frame FRM_ODD, and may be the second gate signals G2[1], G2[2], . . . , G2[m] in the even frame FRM_EVEN. Further, signals of the second gate lines GL2[1], GL2[2], . . . , GL2[m] may be the second gate signals G2[1], G2[2], . . . , G2[m] in the odd frame FRM_ODD, and may be the first gate signals G1[1], G1[2], . . . , G1[m] in the even frame FRM_EVEN.

In an embodiment, the gate driver 122 may include a first inverter INV1, a first switch SW1, a second switch SW2, a third switch SW3, and a fourth switch SW4. The first inverter INV1 may output an inverted dithering signal DTB which is generated by inverting the dithering signal DT. The first switch SW1 may transmit the first clock signal CLK1 to a first clock line CKL1 in response to the dithering signal DT. The second switch SW2 may transmit the second clock signal CLK2 to a second clock line CKL2 in response to the dithering signal DT. The third switch SW3 may transmit the first clock signal CLK1 to the second clock line CKL2 in response to the inverted dithering signal DTB. The fourth switch SW4 may transmit the second clock signal CLK2 to the first clock line CKL1 in response to the inverted dithering signal DTB. A signal of the first clock line CKL1 may be the first clock signal CLK1 in the odd frame FRM_ODD, and may be the second clock signal CLK2 in the even frame FRM_EVEN. A signal of the second clock line CKL2 may be the second clock signal CLK2 in the odd frame FRM_ODD, and may be the first clock signal CLK1 in the even frame FRM_EVEN.

The data driver 132 may provide data voltages S[1], S[2], S[3], . . . , S[n].

The demultiplexer 142 may selectively provide the data voltages S[1], S[2], S[3], . . . , S[n] to the sub-pixels SP1, SP2, and SP3 of the pixels PX1, PX2, PX3, PX4, PX5, PX6, . . . in response to the dithering signal DT, the first selection signal CLA, the second selection signal CLB, and the third selection signal CLC.

In the odd frame FRM_ODD, the demultiplexer 142 may transmit the first selection signal CLA and the third selection signal CLC to the first selection line SL1 and the third selection line SL3, respectively, in response to the dithering signal DT. In the even frame FRM_EVEN, the demultiplexer 142 may transmit the third selection signal CLC and the first selection signal CLA to the first selection line SL1 and the third selection line SL3, respectively, in response to the dithering signal DT. Accordingly, a signal of the first selection line SL1 may be the first selection signal CLA in the odd frame FRM_ODD, and may be the third selection signal CLC in the even frame FRM_EVEN. Further, a signal of the third selection line SL3 may be the third selection signal CLC in the odd frame FRM_ODD, and may be the first selection signal CLA in the even frame FRM_EVEN.

In an embodiment, the demultiplexer 142 may include the first selection line SL1, the second selection line SL2, the third selection line SL3, the first selection transistors TA1, TA2, and TA3, the second selection transistors TB1, TB2, and TB3, the third selection transistors TC1, TC2, and TC3, a second inverter INV2, a fifth switch SW5, a sixth switch SW6, a seventh switch SW7, and an eighth switch SW8. The second selection line SL2 may transmit the second selection signal CLB.

The second inverter INV2 may output an inverted dithering signal DTB which is generated by inverting the dithering signal DT. The fifth switch SW5 may transmit the first selection signal CLA to the first selection line SL1 in response to the dithering signal DT. The sixth switch SW6 may transmit the third selection signal CLC to the third selection line SL3 in response to the dithering signal DT. The seventh switch SW7 may transmit the first selection signal CLA to the third selection line SL3 in response to the inverted dithering signal DTB. The eighth switch SW8 may transmit the third selection signal CLC to the first selection line SL1 in response to the inverted dithering signal DTB. A signal of the first selection line SL1 may be the first selection signal CLA in the odd frame FRM_ODD, and may be the third selection signal CLC in the even frame FRM_EVEN. A signal of the third selection line SL3 may be the third selection signal CLC in the odd frame FRM_ODD, and may be the first selection signal CLA in the even frame FRM_EVEN.

In the odd frame FRM_ODD, when the first selection transistors TA1, TA2, and TA3 are turned on in response to the pulse of the signal of the first selection line SL1, the data voltages S[1], S[2], and S[3] may be charged to the data lines DL connected to the sub-pixels SP1, SP2, and SP3 of the first pixel PX1. When the second selection transistors TB1, TB2, and TB3 are turned on in response to the pulse of the signal of the second selection line SL2, the data voltages S[1], S[2], and S[3] may be charged to the data lines DL connected to the sub-pixels SP1, SP2, and SP3 of the third pixel PX3. The data voltages S[1], S[2], and S[3] charged to the data lines DL may be written to the sub-pixels SP1, SP2, and SP3 of the first and third pixels PX1 and PX3 in response to the pulse of the signal of the first gate line GL1[1], GL1[2], . . . , GL1[m]. When the third selection transistors TC1, TC2, and TC3 are turned on in response to the pulse of the signal of the third selection line SL3, the data voltages S[1], S[2], and S[3] may be charged to the data lines DL connected to the sub-pixels SP1, SP2, and SP3 of the second pixel PX2. The data voltages S[1], S[2], and S[3] charged to the data lines DL may be written to the sub-pixels SP1, SP2, and SP3 of the second pixel PX2 in response to the pulse of the signal of the second gate line GL2[1], GL2[2], . . . , GL2[m].

In the even frame FRM_ODD, when the third selection transistors TC1, TC2, and TC3 are turned on in response to the pulse of the signal of the third selection line SL3, the data voltages S[1], S[2], and S[3] may be charged to the data lines DL connected to the sub-pixels SP1, SP2, and SP3 of the second pixel PX2. The data voltages S[1], S[2], and S[3] charged to the data lines DL may be written to the sub-pixels SP1, SP2, and SP3 of the second pixel PX2 in response to the pulse of the signal of the second gate line GL2[1], GL2[2], . . . , GL2[m]. When the second selection transistors TB1, TB2, and TB3 are turned on in response to the pulse of the signal of the second selection line SL2, the data voltages S[1], S[2], and S[3] may be charged to the data lines DL connected to the sub-pixels SP1, SP2, and SP3 of the third pixel PX3. When the first selection transistors TA1, TA2, and TA3 are turned on in response to the pulse of the signal of the first selection line SL1, the data voltages S[1], S[2], and S[3] may be charged to the data lines DL connected to the sub-pixels SP1, SP2, and SP3 of the first pixel PX1. The data voltages S[1], S[2], and S[3] charged to the data lines DL may be written to the sub-pixels SP1, SP2, and SP3 of the first and third pixels PX1 and PX3 in response to the pulse of the signal of the first gate line GL1[1], GL1[2], . . . , GL1[m].

In an embodiment of the display device 101 described with reference to FIGS. 2 and 3, in the first to third pixels PX1, PX2, and PX3, the data voltages S[1], S[2], and S[3] may be written to the sub-pixels SP1, SP2, and SP3 of one pixel PX2 after the data voltages S[1], S[2], and S[3] are written to the sub-pixels SP1, SP2, and SP3 of two pixels PX1 and PX3. In the fourth to sixth pixels PX4, PX5, and PX6, the data voltages S[1], S[2], and S[3] may be written to the sub-pixels SP1, SP2, and SP3 of two pixels PX4 and PX6 after the data voltages S[1], S[2], and S[3] are written to the sub-pixels SP1, SP2, and SP3 of one pixel PX5. Accordingly, a luminance difference between a first area A1 including the first to third pixels PX1, PX2, and PX3 and a second area A2 including the fourth to sixth pixels PX4, PX5, and PX6 may occur.

In an embodiment of the display device 102 described with reference to FIGS. 8 and 9, in the first to third pixels PX1, PX2, and PX3, the data voltages S[1], S[2], and S[3] may be written to the sub-pixels SP1, SP2, and SP3 of one pixel PX2 after the data voltages S[1], S[2], and S[3] are written to the sub-pixels SP1, SP2, and SP3 of two pixels PX1 and PX3 in the odd frame FRM_ODD, and the data voltages S[1], S[2], and S[3] may be written to the sub-pixels SP1, SP2, and SP3 of two pixels PX1 and PX3 after the data voltages S[1], S[2], and S[3] are written to the sub-pixels SP1, SP2, and SP3 of one pixel PX2 in the even frame FRM_EVEN. In the fourth to sixth pixels PX4, PX5, and PX6, the data voltages S[1], S[2], and S[3] may be written to the sub-pixels SP1, SP2, and SP3 of two pixels PX4 and PX6 after the data voltages S[1], S[2], and S[3] are written to the sub-pixels SP1, SP2, and SP3 of one pixel PX5 in the odd frame FRM_ODD, and the data voltages S[1], S[2], and S[3] may be written to the sub-pixels SP1, SP2, and SP3 of two pixels PX4 and PX6 after the data voltages S[1], S[2], and S[3] are written to the sub-pixels SP1, SP2, and SP3 of one pixel PX5 in the even frame FRM_EVEN. Accordingly, the luminance difference between the first area A1 including the first to third pixels PX1, PX2, and PX3 and the second area A2 including the fourth to sixth pixels PX4, PX5, and PX6 may be substantially reduced.

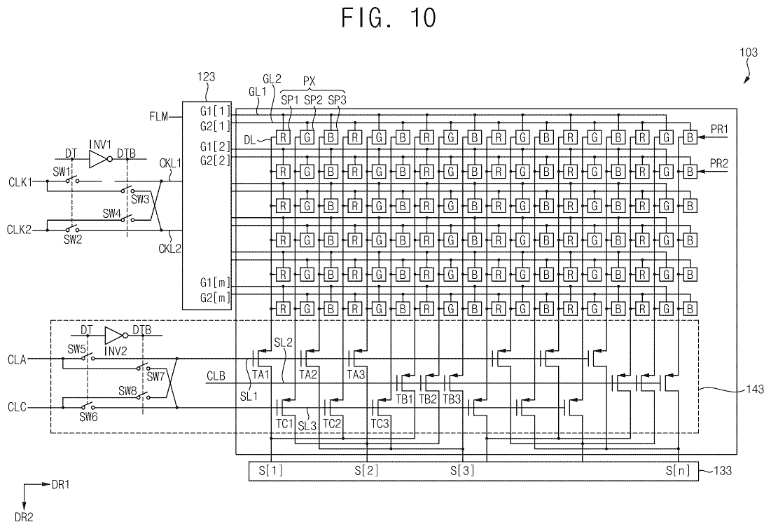

FIG. 10 is a block diagram illustrating a display device 103 according to an embodiment.

For convenience of description, any repetitive detailed descriptions of the same or like components of the display device 103 shown in FIG. 10, which are substantially the same as or similar to those of the display device 102 described with reference to FIGS. 8 and 9, will be omitted or simplified.

Referring to FIG. 10, an embodiment of the display device 103 may include a display panel 113, a gate driver 123, a data driver 133, and a demultiplexer 143.

In such an embodiment, the first gate line GL1 and the second gate line GL2 may be alternately connected to the pixel row on a sub-pixel by sub-pixel basis. In an embodiment, the first gate line GL1 may be connected to odd sub-pixels in the first direction DR1, and the second gate line GL2 may be connected to even sub-pixels in the first direction DR1.

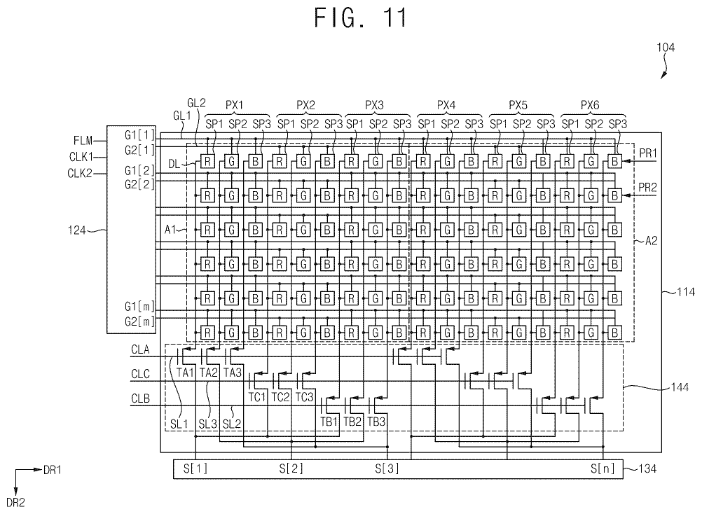

FIG. 11 is a block diagram illustrating a display device 104 according to an embodiment.

For convenience of description, any repetitive detailed descriptions of the same or like components of the display device 104 shown in FIG. 11, which are substantially the same as or similar to those of the display device 101 described with reference to FIGS. 2 and 3, will be omitted or simplified.

Referring to FIG. 11, an embodiment, the display device 104 may include a display panel 114, a gate driver 124, a data driver 134, and a demultiplexer 144.

In such an embodiment, the first gate line GL1 and the second gate line GL2 may be repeatedly connected to the pixel row on a pixel group basis. The pixel group may include three pixels. In an embodiment, the first gate line GL1 may be connected to the sub-pixels SP1, SP2, and SP3 of the first and third pixels in the first direction DR1 in the pixel group, and the second gate line GL2 may be connected to the sub-pixels SP1, SP2, and SP3 of the second pixel in the first direction DR1 in the pixel group. In an embodiment, for example, the first gate line GL1 may be connected to the sub-pixels SP1, SP2, and SP3 of the first, third, fourth, and sixth pixels PX1, PX3, PX4, and PX6, and the second gate line GL2 may be connected to the sub-pixels SP1, SP2, and SP3 of the second and fifth pixels PX2 and PX5.

In an embodiment of the display device 104 described with reference to FIG. 11, in the first to third pixels PX1, PX2, and PX3, the data voltages S[1], S[2], and S[3] may be written to the sub-pixels SP1, SP2, and SP3 of one pixel PX2 after the data voltages S[1], S[2], and S[3] are written to the sub-pixels SP1, SP2, and SP3 of two pixels PX1 and PX3. In the fourth to sixth pixels PX4, PX5, and PX6, the data voltages S[1], S[2], and S[3] may be written to the sub-pixels SP1, SP2, and SP3 of one pixel PX5 after the data voltages S[1], S[2], and S[3] are written to the sub-pixels SP1, SP2, and SP3 of two pixels PX4 and PX6. Accordingly, the luminance difference between the first area A1 including the first to third pixels PX1, PX2, and PX3 and the second area A2 including the fourth to sixth pixels PX4, PX5, and PX6 may not occur.

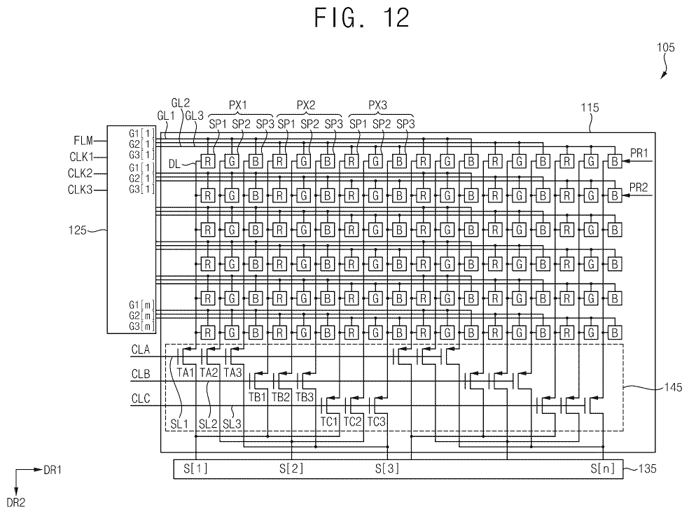

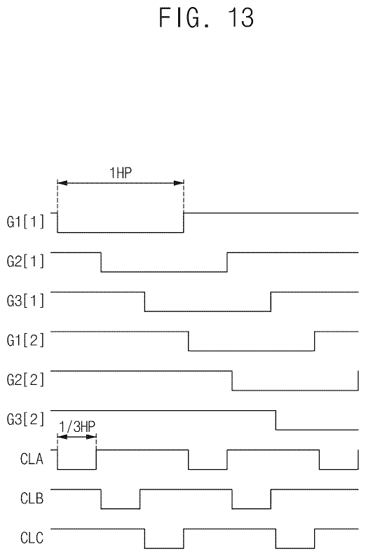

FIG. 12 is a block diagram illustrating a display device 105 according to an embodiment. FIG. 13 is a signal timing diagram illustrating gate signals G1[1], G2[1], G3[1], G1[2], G2[2], and G3[2] and selection signals CLA, CLB, and CLC of FIG. 12.

For convenience of description, any repetitive detailed descriptions of the same or like components of the display device 105 shown in FIGS. 12 and 13, which are substantially the same as or similar to those of the display device 101 described with reference to FIGS. 2 and 3, will be omitted or simplified.

Referring to FIGS. 12 and 13, an embodiment of the display device 105 may include a display panel 115, a gate driver 125, a data driver 135, and a demultiplexer 145.

The display panel 115 may include a plurality of pixel rows PR1, PR2, . . . , a plurality of first gate lines GL1, a plurality of second gate lines GL2, a plurality of third gate lines GL3, and a plurality of data lines DL.

The first gate lines GL1, the second gate lines GL2, and the third gate lines GL3 may extend in the first direction DR1, and may be arranged in the second direction DR2. Each of the first gate lines GL1, each of the second gate lines GL2, and each of the third gate lines GL3 may be connected to a corresponding pixel row among the pixel rows PR1, PR2, . . . . In other words, one first gate line GL1, one second gate line GL2, and one third gate line GL3 may be connected to one pixel row.

The first gate line GL1, the second gate line GL2, and the third gate line GL3 may be alternately connected to the pixel row on a pixel-by-pixel basis. In an embodiment, the first gate line GL1 may be connected to the sub-pixels SP1, SP2, and SP3 of the first pixel PX1, the second gate line GL2 may be connected to the sub-pixels SP1, SP2, and SP3 of the second pixel PX2, and the third gate line GL2 may be connected to the sub-pixels SP1, SP2, and SP3 of the third pixel PX3.

The gate driver 125 may provide a plurality of first gate signals G1[1], G1[2], . . . , G1[m] to the first gate lines GL1, may provide a plurality of second gate signals G2[1], G2[2], . . . , G2[m] to the second gate lines GL2, and may provide a plurality of third gate signals G3[1], G3[2], . . . , G3[m] to the third gate lines GL3. The gate driver 125 may provide a first first gate signal G1[1] to the first gate line GL1 connected to a first pixel row PR1, may provide a first second gate signal G2[1] to the second gate line GL2 connected to the first pixel row PR1, and may provide a first third gate signal G3[1] to the third gate line GL3 connected to the first pixel row PR1. The gate driver 125 may generate the first gate signals G1[1], G1[2], . . . , G1[m] based on the gate start signal FLM and a first clock signal CLK1, may generate the second gate signals G2[1], G2[2], . . . , G2[m] based on the gate start signal FLM and a second clock signal CLK2, and may generate the third gate signals G3[1], G3[2], . . . , G3[m] based on the gate start signal FLM and a third clock signal CLK3.

The second gate signal G2[1], G2[2], . . . , G2[m] may be a signal in which the first gate signal G1[1], G1[2], . . . , G1[m] is shifted by ⅓ horizontal time interval ⅓HP, and the third gate signal G3[1], G3[2], . . . , G3[m] may be a signal in which the second gate signal G2[1], G2[2], . . . , G2[m] is shifted by ⅓ horizontal time interval ⅓HP. In an embodiment, each of the first gate signal G1[1], G1[2], . . . , G1[m], the second gate signal G2[1], G2[2], . . . , G2[m], and the third gate signal G3[1], G3[2], . . . , G3[m] may have a pulse having a width corresponding to (e.g., equal to) one horizontal time interval 1HP, and the pulse of the first gate signal G1[1], G1[2], . . . , G1[m], the pulse of the second gate signal G2[1], G2[2], . . . , G2[m], and the pulse of the third gate signal G3[1], G3[2], . . . , G3[m] may partially overlap each other.

When the first selection transistors TA1, TA2, and TA3 are turned on in response to a pulse of the first selection signal CLA, the data voltages S[1], S[2], and S[3] may be charged to the data lines DL connected to the sub-pixels SP1, SP2, and SP3 of the first pixel PX1. The data voltages S[1], S[2], and S[3] charged to the data lines DL may be written to the sub-pixels SP1, SP2, and SP3 of the first pixel PX1 in response to the pulse of the first gate signal G1[1], G1[2], . . . .

When the second selection transistors TB1, TB2, and TB3 are turned on in response to a pulse of the second selection signal CLB, the data voltages S[1], S[2], and S[3] may be charged to the data lines DL connected to the sub-pixels SP1, SP2, and SP3 of the second pixel PX2. The data voltages S[1], S[2], and S[3] charged to the data lines DL may be written to the sub-pixels SP1, SP2, and SP3 of the second pixel PX2 in response to the pulse of the second gate signal G2[1], G2[2], . . . .

When the third selection transistors TC1, TC2, and TC3 are turned on in response to a pulse of the third selection signal CLC, the data voltages S[1], S[2], and S[3] may be charged to the data lines DL connected to the sub-pixels SP1, SP2, and SP3 of the third pixel PX3. The data voltages S[1], S[2], and S[3] charged to the data lines DL may be written to the sub-pixels SP1, SP2, and SP3 of the third pixel PX3 in response to the pulse of the third gate signal G3[1], G3[2], . . . .

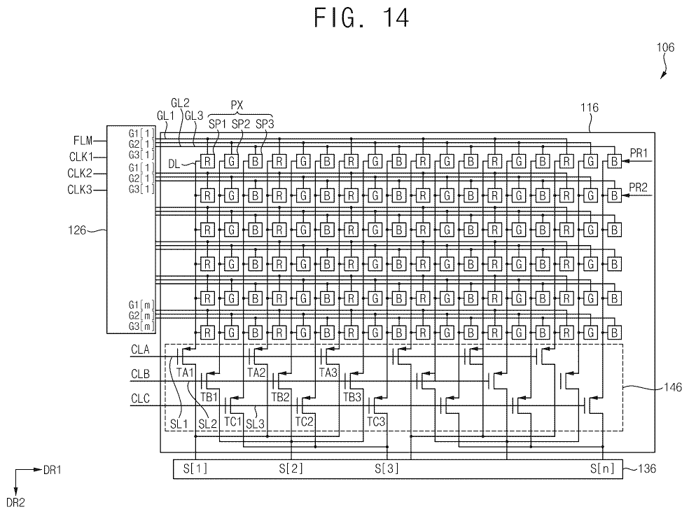

FIG. 14 is a block diagram illustrating a display device 106 according to an embodiment.

For convenience of description, any repetitive detailed descriptions of the same or like components of the display device 106 shown in FIG. 14, which are substantially the same as or similar to those of the display device 105 described with reference to FIGS. 12 and 13, will be omitted or simplified.

Referring to FIG. 14, an embodiment of the display device 106 may include a display panel 116, a gate driver 126, a data driver 136, and a demultiplexer 146.

In such an embodiment, the first gate line GL1, the second gate line GL2, and the third gate line GL3 may be alternately connected to the pixel row on a sub-pixel by sub-pixel basis. In an embodiment, the first gate line GL1 may be connected to (3k-2)^{th} sub-pixels in the first direction DR1, the second gate line GL2 may be connected to (3k-1)^{th} sub-pixels in the first direction DR1, and the third gate line GL3 may be connected to 3k^{th} sub-pixels in the first direction DR1, where k is a natural number greater than or equal to 1.

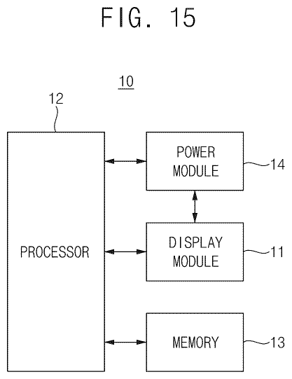

FIG. 15 is a block diagram illustrating an electronic device 10 according to an embodiment.

Referring to FIG. 15, an embodiment of the electronic device 10 may include a display module 11, a processor 12, a memory 13, and a power module 14.

The processor 12 may include at least one selected from a central processing unit (CPU), an application processor (AP), a graphic processing unit (GPU), a communication processor (CP), an image signal processor (ISP), and a controller.

The memory 13 may store data information used for an operation of the processor 12 or the display module 11. When the processor 12 executes an application stored in the memory 13, the input image data IDAT of FIG. 1 and the control signal CTRL of FIG. 1 may be transmitted to the display module 11, and the display module 11 may output image information based on the input image data IDAT and the control signal CTRL.

The power module 14 may include a power supply module such as a power adapter, a battery device, etc. and a power conversion module that converts power supplied by the power supply module to generate power used for an operation of the electronic device 10.

At least one of the components of the electronic device 10 described above may be included in the display device 100 of FIG. 1, 101 of FIG. 2, 102 of FIG. 8, 103 of FIG. 10, 104 of FIG. 11, 105 of FIG. 12, or 106 of FIG. 14 according to the embodiments described above. Further, some of individual modules functionally included in one module may be included in the display device 100, 101, 102, 103, 104, 105, or 106, and others may be provided separately from the display device 100, 101, 102, 103, 104, 105, or 106. In an embodiment, for example, the display device 100, 101, 102, 103, 104, 105, or 106 may include the display module 11, and the processor 12, the memory 13, and the power module 14 may be provided in the form of other devices within the electronic device 11 other than the display device 100, 101, 102, 103, 104, 105, or 106.

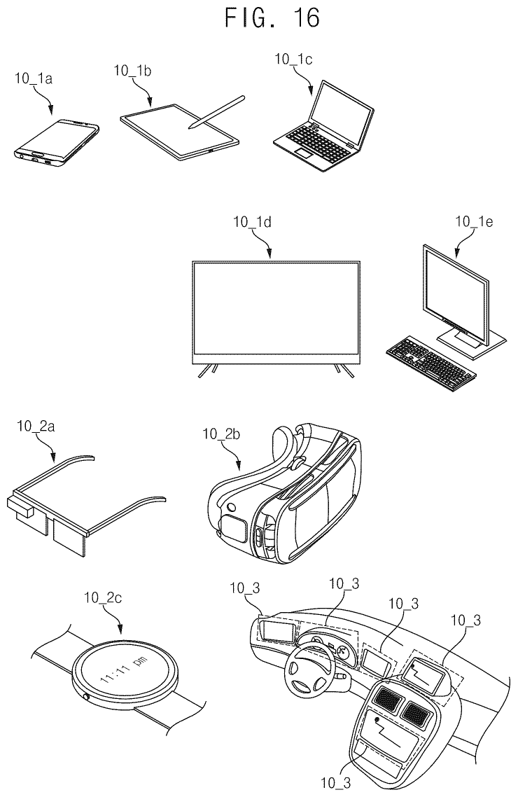

FIG. 16 is a diagram illustrating electronic devices according to embodiments.

Referring to FIG. 16, electronic devices, in which display devices according to embodiments are included, may include not only image display electronic devices such as a smart phone 10_1a, a tablet personal computer (PC) 10_1b, a laptop computer 10_1c, a television (TV) 10_1d, a desk monitor 10_1e, etc. but also wearable electronic devices including display modules such as smart glasses 10_2a, a head mounted display 10_2b, a smart watch 10_2c, etc., vehicle electronic devices 10_3 including display modules such as an instrument panel of an automobile, a center fascia, a center information display (CID) arranged on a dashboard, a room mirror display, etc.

The display device according to embodiments may be applied to a display device included in a computer, a notebook, a mobile phone, a smart phone, a smart pad, a smart watch, a portable media player (PMP), a personal digital assistant (PDA), an MP3 player, or the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display device comprising:
a display panel comprising a pixel row comprising pixels arranged in a first direction, and a first gate line and a second gate line connected to the pixel row, wherein each of the pixels comprises sub-pixels arranged in the first direction;
a gate driver which provides a first gate signal and a second gate signal shifted by ⅓ horizontal time interval of the first gate signal to the first gate line and the second gate line;
a data driver which provides data voltages; and
a demultiplexer which selectively provides the data voltages from the data driver to the sub-pixels of the pixels in response to a first selection signal, a second selection signal shifted by ⅓ horizontal time interval of the first selection signal, and a third selection signal shifted by ⅓ horizontal time interval of the second selection signal,
wherein the demultiplexer comprises:
a first selection transistor comprising a gate connected to a first selection line;
a second selection transistor comprising a gate connected to a second selection line which transmits the second selection signal; and
a third selection transistor comprising a gate connected to a third selection line.

2. The display device of claim 1, wherein, in an odd frame, the gate driver transmits the first gate signal and the second gate signal to the first gate line and the second gate line, respectively, in response to a dithering signal, and the demultiplexer transmits the first selection signal and the third selection signal to the first selection line and the third selection line, respectively, in response to the dithering signal, and
wherein, in an even frame, the gate driver transmits the second gate signal and the first gate signal to the first gate line and the second gate line, respectively, in response to the dithering signal, and the demultiplexer transmits the third selection signal and the first selection signal to the first selection line and the third selection line, respectively, in response to the dithering signal.

3. The display device of claim 2, wherein the dithering signal has a logic high level in the odd frame, and has a logic low level in the even frame.

4. The display device of claim 2, wherein the gate driver comprises:
a first inverter which outputs an inverted dithering signal generated by inverting the dithering signal;
a first switch which transmits a first clock signal to a first clock line in response to the dithering signal;
a second switch which transmits a second clock signal to a second clock line in response to the dithering signal;
a third switch which transmits the first clock signal to the second clock line in response to the inverted dithering signal; and
a fourth switch which transmits the second clock signal to the first clock line in response to the inverted dithering signal.

5. The display device of claim 2, wherein the gate driver comprises:
a second inverter which outputs an inverted dithering signal generated by inverting the dithering signal;
a fifth switch which transmits the first selection signal to the first selection line in response to the dithering signal;
a sixth switch which transmits the third selection signal to the third selection line in response to the dithering signal;
a seventh switch which transmits the first selection signal to the third selection line in response to the inverted dithering signal; and
an eighth switch which transmits the third selection signal to the first selection line in response to the inverted dithering signal.

6. The display device of claim 2, wherein the first gate line and the second gate line are alternately connected to the pixel row on a pixel-by-pixel basis.

7. The display device of claim 2, wherein the first gate line and the second gate line are alternately connected to the pixel row on a sub-pixel by sub-pixel basis.

8. The display device of claim 2, wherein each of the first gate signal and the second gate signal has a pulse having a width corresponding to ⅔ horizontal time interval, and
wherein the pulse of the first gate signal and the pulse of the second gate signal partially overlap each other.

9. The display device of claim 1, wherein each of the first selection signal, the second selection signal, and the third selection signal has a pulse having a width corresponding to ⅓ horizontal time interval, and
wherein the pulse of the first selection signal, the pulse of the second selection signal, and the pulse of the third selection signal do not overlap each other.

10. The display device of claim 1, wherein the display panel further comprises third gate line connected to the pixel row, and wherein the gate driver provides the first gate signal, the second gate signal, and a third gate signal shifted by ⅓ horizontal time interval of the second gate signal to the first gate line, the second gate line, and the third gate line, respectively.

11. The display device of claim 10, wherein the first gate line, the second gate line, and the third gate line are alternately connected to the pixel row on a pixel-by-pixel basis.

12. The display device of claim 10, wherein the first gate line, the second gate line, and the third gate line are alternately connected to the pixel row on a sub-pixel by sub-pixel basis.

13. The display device of claim 10, wherein each of the first gate signal, the second gate signal, and the third gate signal has a pulse having a width corresponding to one horizontal time interval, and
wherein the pulse of the first gate signal, the pulse of the second gate signal, and the pulse of the third gate signal partially overlap each other.

14. An electronic device comprising:
a processor; and
a display device which receives input image data from the processor, wherein the display device displays an image corresponding to the input image data,
wherein the display device comprises:
a display panel comprising a pixel row comprising pixels arranged in a first direction, and a first gate line and a second gate line connected to the pixel row,
wherein each of the pixels comprises sub-pixels arranged in the first direction;
a gate driver which provides a first gate signal and a second gate signal shifted by ⅓ horizontal time interval of the first gate signal to the first gate line and the second gate line;
a data driver which provides data voltages; and
a demultiplexer which selectively provides the data voltages from the data driver to the sub-pixels of the pixels in response to a first selection signal, a second selection signal shifted by ⅓ horizontal time interval of the first selection signal, and a third selection signal shifted by ⅓ horizontal time interval of the second selection signal,
wherein the demultiplexer comprises:
a first selection transistor comprising a gate connected to a first selection line;
a second selection transistor comprising a gate connected to a second selection line which transmits the second selection signal; and
a third selection transistor comprising a gate connected to a third selection line.

15. The electronic device of claim 14, wherein, in an odd frame, the gate driver transmits the first gate signal and the second gate signal to the first gate line and the second gate line, respectively, in response to a dithering signal, and the demultiplexer transmits the first selection signal and the third selection signal to the first selection line and the third selection line, respectively, in response to the dithering signal, and
wherein, in an even frame, the gate driver transmits the second gate signal and the first gate signal to the first gate line and the second gate line, respectively, in response to the dithering signal, and the demultiplexer transmits the third selection signal and the first selection signal to the first selection line and the third selection line, respectively, in response to the dithering signal.

16. The electronic device of claim 15, wherein the dithering signal has a logic high level in the odd frame, and has a logic low level in the even frame.

17. The electronic device of claim 15, wherein the first gate line and the second gate line are alternately connected to the pixel row on a pixel-by-pixel basis.

18. The electronic device of claim 15, wherein the first gate line and the second gate line are alternately connected to the pixel row on a sub-pixel by sub-pixel basis.

19. The electronic device of claim 15, wherein each of the first gate signal and the second gate signal has a pulse having a width corresponding to ⅔ horizontal time interval, and
wherein the pulse of the first gate signal and the pulse of the second gate signal partially overlap each other.

20. The electronic device of claim 14, wherein each of the first selection signal, the second selection signal, and the third selection signal has a pulse having a width corresponding to ⅓ horizontal time interval, and
wherein the pulse of the first selection signal, the pulse of the second selection signal, and the pulse of the third selection signal do not overlap each other.
